(19) United States
(12) Patent Application Publication
(10) Pub. No.: US 2005/0253905 A1
(43) Pub. Date: Nov. 17, 2005

(54) Droplet generation by transverse disturbances

(76) Inventors: Melissa Orme-Marmerelis, Irvine, CA (US); Robert F. Smith, Costa Mesa, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 10/519,171

(22) PCT Filed: Jul. 25, 2003
(86) PCT No.: PCT/US03/23424

§ 371 Date: Dec. 20, 2004

(30) Foreign Application Priority Data
Jul. 26, 2002 (US) 60399054

(51) Int. Cl. B41J 2/02

(52) U.S. Cl. 347/75

(57) ABSTRACT

The present invention enables the formation of droplets due to capillary stream break-up and minimizes variation in droplet formation time by applying a transverse disturbance to initiate instability on the capillary stream's surface. In one embodiment, a side-shaker apparatus comprises a reservoir adapted to hold molten metal, an orifice plate having an orifice in fluid communication with the reservoir, and a transverse disturbance generating member coupled to the orifice plate. The molten metal in the reservoir is ejected from the orifice to form a capillary stream. Due to capillary stream break-up, droplets pinch off from the capillary stream to form a droplet stream. The transverse disturbance generating member vibrates the orifice plate laterally (i.e., side to side) to apply a transverse disturbance to the capillary stream.

This invention was made with Government support under Grant No. DMI-0070053, awarded by NSF. The Government has certain rights in this invention.

### FIELD OF THE INVENTION

The invention relates to droplet generation from capillary stream break-up and, more particularly, to methods and systems that facilitate robust generation of droplets utilizing transverse disturbances.

### BACKGROUND OF THE INVENTION

The generation of droplets from capillary stream break-up has been studied at least as early as Lord Rayleigh in the 1800s. Droplet generation from capillary stream break-up is gaining considerable attention due to several emerging applications that require the reliable generation and placement of micro-liter sized molten metal droplets and that rely on the precise control of droplet formation, charging, deflection and deposition or collection. When the droplets are electrostatically charged and deflected, it is critical that the droplet formation time be invariant since the droplet charge value is synchronized with the droplet formation time. While droplets emanating from a host of current droplet generators appear to be stable, inasmuch as they are uniformly separated and sized, the time of droplet pinch-off from the capillary stream (e.g., the time of droplet formation) varies significantly with time. Unless these droplets are electrostatically charged and deflected, the memory of the variation of droplet formation time is lost and inconsequential. However, if these droplets are indeed charged and deflected, gross errors in droplet placement will occur due to the variance in break-up time.

In conventional droplet generation methods, a disturbance is imparted on the stream by imposing a standing wave in a fluid reservoir or by oscillating the orifice in the direction of the long axis of the resulting droplet stream, which tends to lead to variations in droplet breakup distance due to variations in liquid height which, in turn, cause variations in the standing wave characteristics. An example of a conventional droplet formation mode, sometimes referred to as “plunger-mode,” is described with regard to FIG. 1 in which a “plunger-mode” apparatus 10 is illustrated.

The plunger-mode apparatus 10 comprises a reservoir 14 adapted to hold molten metal 16, and a vibrating rod 18 immersed in the molten metal 16. The rod 18 is mechanically coupled to a piezoelectric crystal (pzt) 20, which vibrates the rod 18 longitudinally. The molten metal 16 is ejected from the reservoir 14 through an orifice 30, from which a capillary stream 32 of molten metal forms. Due to capillary stream break-up, droplets pinch off from the stream 32 to form a droplet stream 34.

In this mode of droplet generation, the rod 18 vibrates along the same axis of the droplet stream 34 and is immersed in the fluid 16 (i.e., molten metal). This mode results in the establishment of standing waves in the fluid 16 that change in time as the fluid level decreases due to the generation of droplets. The variation in acoustic properties with time necessarily creates variations in droplet formation time—the leading cause of droplet charging, deflection and placement errors. Additionally, because the rod 18 is immersed directly into the molten liquid 16, the heat transfer more directly affects the piezoelectric crystal 20 necessitating active measures of crystal cooling, even for moderate temperatures. Furthermore, failure to align the long thin rod 18 directly over the orifice 30 will lead to the initiation of non-axisymmetric disturbances, degrading the reliability of droplet generation. Guides and o-rings can be added to the apparatus, but care must be taken to dynamically load the rod 18 in an identical manner for each experimental realization, to restrain the rod 18 from lateral shifts, yet to allow the rod 18 enough freedom to vibrate along its long axis. All of the above apparatus modifications are possible, but add several layers of complication to the system that are not preferable.

Thus, it would be desirable to have systems and methods that minimize the variations in droplet formation and the complication of the system.

### SUMMARY OF THE INVENTION

Accordingly, the present invention enables the formation of droplets due to capillary stream break-up and minimizes the variations in droplet formation time by applying transverse vibrations to initiate the instability on the capillary stream's surface. The present invention produces a stream of droplets with significantly less variation in droplet formation time than other practiced methods. Additionally, with the method of the present invention, reliable droplet generation can occur over a broader range of frequencies, requires less driving power applied to the piezoelectric crystal that provides the perturbation, and is more convenient with respect to hardware design and cooling considerations.

In one embodiment, a side-shaker apparatus for applying a transverse disturbance comprises a reservoir adapted to hold molten metal, an orifice plate having an orifice in fluid communication with the reservoir, and a transverse disturbance generating member coupled to the orifice plate. The molten metal in the reservoir is ejected from the orifice to form a capillary stream. Due to capillary stream break-up, droplets pinch off from the capillary stream to form a droplet stream. The transverse disturbance generating member vibrates the orifice plate laterally (i.e., side to side) to apply a transverse disturbance to the capillary stream.

In another embodiment, the transverse disturbance generating member comprises a piezoelectric crystal.

Other aspects and features of the present invention will become apparent from consideration of the following description taken in conjunction with the accompanying drawings.

### BRIEF DESCRIPTION OF THE DRAWINGS

FIG. 1 is a schematic diagram of a conventional “plunger-mode” droplet generation system.

FIG. 2 is a schematic diagram of a transverse mode perturbation droplet generation system.

FIG. 3 is a plot of droplet stream responses of a droplet generation system to a sine wave transverse excitation input.

FIG. 4 is a plot of droplet stream responses of a droplet generation system to a sine wave plunger excitation input.

FIGS. 5A and 5B are contour plots of the acoustic response of the transverse mode perturbation droplet generation system subject to the transverse mode of droplet formation and a sinewave perturbation. 5A is the spectral response of the input disturbance to the apparatus and 5B is spectral response of the apparatus to the input.

FIGS. 6A and 6B are contour plots of the acoustic response of an apparatus subject to the plunger mode of droplet formation and a sine wave perturbation. 6A is the spectral response of the input disturbance to the apparatus and 6B is spectral response of the apparatus to the input.

FIG. 7 is a plot of droplet stream responses of a droplet generation system to a square wave transverse excitation input.

FIG. 8 is a plot of droplet stream responses of a droplet generation system to a square wave plunger excitation input.

FIGS. 9A and 9B are contour plots of the acoustic response of an apparatus subject to the transverse excitation mode of droplet formation and a square wave perturbation. 9A is the spectral response of the input disturbance to the apparatus and 9B is the spectral response of the apparatus to the input.

FIGS. 10A and 10B are contour plots of the acoustic response of an apparatus subject to the plunger mode of droplet formation and a square wave perturbation. 10A is the spectral response of the input disturbance to the apparatus and 10B is the spectral response of the apparatus to the input.

FIG. 11 shows the movement of a droplet break-up distance over time. The diamond symbols are for the plunger mode of excitation and squares are for the transverse mode of excitation.

FIGS. 12A and 12B are contour plots of the acoustic response of the apparatus over a time interval of 70 minutes when excited with a sine wave perturbation at 11280 Hz (this frequency is indicated on the plots of FIGS. 3 and 4). 12A is the spectral response of the apparatus subject to the side-shaker mode and 12B is the spectral response of the apparatus subject to the plunger mode.

FIG. 13 is a plot comparing the response of a capillary stream to a sine wave transverse-mode excitation and a sine wave longitudinal-mode excitation for a range of frequencies.

FIG. 14 is a plot of the voltage required to achieve droplet formation at a loction of 5.2 mm from the exit face of an orifice for the transverse and longitudinal modes of droplet generation.

FIG. 15 is a plot comparing the response of a capillary stream to a square wave transverse-mode excitation and a square wave longitudinal-mode excitation for a range of frequencies.

FIG. 16 are contour plots of the acoustic response of the transverse-mode and longitudinal-mode apparatuses over a time interval of 70 minutes when excited with a sine wave perturbation with kₒ^{*}=0.65.

FIG. 17 is a plot of the variation in the droplet formation location over time for the transverse mode of droplet generation for five different forcing conditions.

FIG. 18 is a plot of the variation in the droplet formation location over time for the longitudinal mode of droplet generation for five different forcing conditions.

FIG. 19 is a plot comparing the breakup location as a function of time for the transverse and longitudinal modes of droplet generation.

FIG. 20 is a schematic diagram of a transverse mode perturbation droplet generation system using acoustic waves.

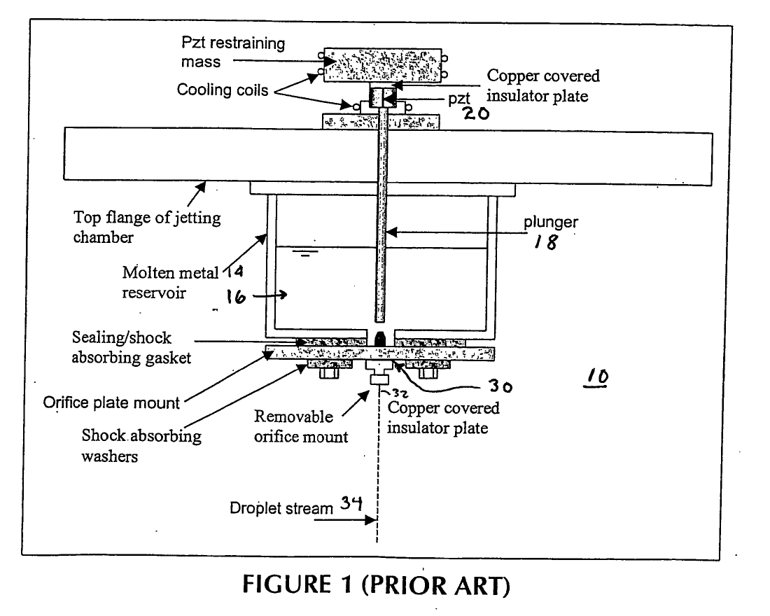

### DETAILED DESCRIPTION OF THE PREFERRED EMBODIMENTS

In accordance with the present invention, droplets are formed due to capillary stream break-up while minimizing the variations in droplet formation time by applying transverse vibrations to initiate the instability on the capillary stream's surface. The present invention produces a stream of droplets with significantly less variation in droplet formation time than other practiced methods. Additionally, with the method of the present invention, reliable droplet generation can occur over a broader range of frequencies, requires less driving power applied to the piezoelectric crystal that provides the perturbation, and is more convenient with respect to hardware design and cooling considerations.

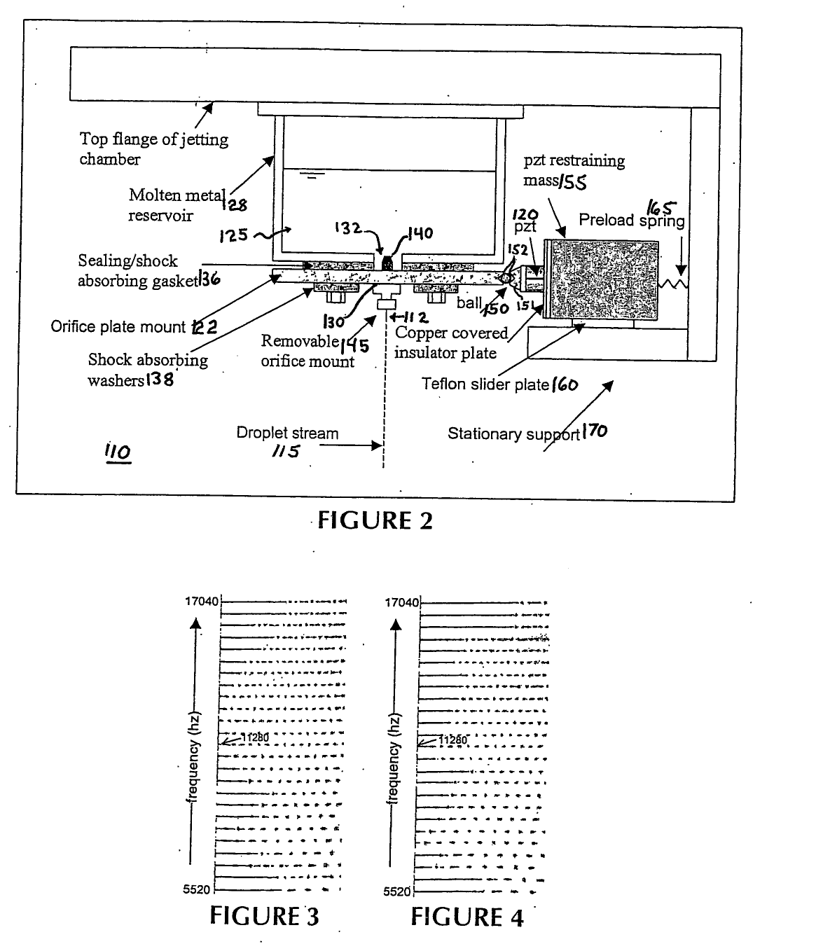

The present invention includes a method of droplet generation that is based on the application of a transverse perturbation or side shaking. FIG. 2 illustrates a conceptual schematic of a transverse perturbation or “side-shaker” apparatus 110. The apparatus 110 comprises a piezoelectric crystal (pzt) 120 mechanically coupled to an orifice plate mount 122, from which a capillary stream 112 forms. Due to capillary stream break-up, droplets pinch off from the capillary stream 112 to form a droplet stream 115. Motion from the pzt 120 slides the orifice plate mount 122 laterally (i.e., side to side) in a direction that is orthogonal to the axis of the droplet stream 115 as shown. The lateral motion of the orifice plate 122 applies a transverse disturbance to the capillary stream 112.

Although the orifice plate 112 is shown having a flat-rectangular cross section, this shape is not necessary to practice the invention. The orifice plate 112 may have another shape as long as the pzt 120 slides the orifice plate 122 side to side to impart a transverse disturbance to the capillary stream 112. Also, other means besides a pzt can be used to effectuate side-to-side movement of the orifice plate 122.

The apparatus 110 comprises a reservoir 128 adapted to hold molten metal 125. The reservoir 128 may be made of titanium, ceramic or any other suitable material having a higher melting point than the molten metal 125. The orifice plate 122 is attached to the bottom of the reservoir 128. The reservoir 128 has a bottom opening 132 through which the molten metal 125 flows to the orifice plate 122. The orifice plate 122 has an orifice 130 in fluid communication with the reservoir 128 via the bottom opening 132. The molten metal 125 is ejected from the orifice 130 to form the capillary stream 112.

The apparatus 110 further comprises shock absorbing gaskets 136 disposed between the bottom of the reservoir 128 and the orifice plate 122, and shock absorbing washers 138 secured to the bottom of the orifice plate 112. The shock absorbing gaskets 136 and washers 138, which may be made of graphite, are used to reduce the transmission of unwanted frequency modes to the apparatus 110, though we have observed stable operation without their existence.

The apparatus 110 also comprises a circular nozzle 140 positioned over the orifice 130. The nozzle 140 is secured to the orifice plate 122 by a hollow nut 145, through which the molten metal 125 can pass to form the capillary stream 112. The nozzle 140 and the hollow nut 145 are optional since the apparatus 110 only requires an orifice 130 to form the capillary stream 112.

The apparatus 110 also comprises a spacer element 150, preferably in the form of a ball, disposed between the orifice plate 122 and the pzt 120 to reduce the transfer of heat from the orifice plate 122 to the pzt 120. The ball 150 contacts conical grooves 152 in the orifice plate 122 and a pzt coupler 151. The contact between the ball's 150 spherical surface and the conical grooves 152 provides a relatively small contact surface area between the ball 150 and the grooves 152. The small contact surface area reduces thermal conduction between the orifice plate 122 and the pzt 120, thereby reducing the transfer of heat from the orifice plate 122 to the pzt 120.

Other methods may be employed to protect the pzt 120 from the heat of the molten metal 125. For example, the length of the orifice plate 122 can be increased to increase the distance, and thereby the thermal conduction path, between the orifice 130 and the pzt 120. Alternatively or in addition, the distance between the ball 150 and the pzt 120 may be increased. Also, an active cooling system (not shown) may be used to protect the pzt 120 from heat degradation. The active cooling system may, for example, circulate water or other cooling fluid around the pzt 120 to keep it sufficiently cool. For the generation of low melting point metals, such as solder, it may be possible to position the pzt 120 near the orifice 130 with no active cooling system. For the generation of high melting point metals and alloys, the distance between the pzt 120 and the ball 150 can be increased and subjected to active cooling to reduce the effects of pzt 120 degradation due to heat transfer.

The apparatus 110 further comprises a pzt restraining mass 155 to restrain the side of the pzt 120 opposite the orifice plate 122. This is done so that most of the pzt's 120 lateral vibrations are transmitted to the orifice plate 122. The pzt restraining mass 155 may be a lead weight. The apparatus 110 also comprises a stationary support 170 for supporting the pzt 120 and the pzt restraining mass 155. The pzt restraining mass 155 rests on a Teflon slider plate 160 on the stationary support 170. In practice, the pzt restraining mass 155 may slide only a fraction of a micron on the slider plate 170. A preload spring 165 is disposed between the pzt restraining mass 155 and the stationary support 170 as shown. The slider plate 160 and the preload spring 165 are used to reduce transmission of the pzt's 120 vibrations to the stationary support 170.

During operation, an alternating electrical signal is applied to the pzt 120, causing the pzt 120 to vibrate in the lateral direction. The pzt's 120 lateral vibrations slide the orifice plate 122 side to side, which imparts a transverse disturbance to the capillary stream 112 as it passes through the orifice 130. The lateral motion minimizes the establishment of an acoustic wave that would otherwise travel back and forth within the molten metal 125 itself, thereby changing its characteristics as the depth of the fluid changes.

The side-shaker apparatus 110 of the present invention offers several advantages over the plunger-mode apparatus of the prior art. First, the side-shaker apparatus 110 dramatically reduces the formation of standing waves in the fluid (i.e., molten metal 125) compared to the plunger-mode apparatus. This is because the side-shaker apparatus 110 imparts a transverse disturbance to the capillary stream 112 instead of vibrating a rod immersed in the fluid. The reduction of standing waves in the fluid is desirable because standing waves in the fluid change with time as the fluid level decreases due to droplet formation. The resulting variation in acoustic properties with time creates a variation in droplet formation time—the leading cause of droplet charging, deflection and placement errors. By minimizing the formation of standing waves in the fluid, the invention produces a droplet stream with significantly less variation in droplet formation time—leading to more accurate charging, deflection and placement of the droplets.

Second, the side-shaker apparatus 110 reduces heat transfer from the molten metal 125 to the pzt 120 compared to the plunger-mode apparatus. In the plunger-mode apparatus, the rod is immersed directly into the molten metal, which increases the conduction of heat from the molten metal to the pzt. By contrast, in the side-shaker apparatus 110, only a small portion of the orifice plate 122 is in direct contact with the molten metal 125.

Third, the side-shaker apparatus 110 is more convenient to implement than the plunger-mode apparatus. The plunger-mode apparatus often employs guides and o-rings to align the rod directly over the orifice along the axis of the droplet stream. This is because failure to align the rod directly over the orifice will lead to the initiation of non-axisymmetric disturbances, degrading the reliability of droplet formation. The guides and o-rings add several layers of complication to the plunger-mode apparatus that are not necessary in the side-shaker apparatus 110.

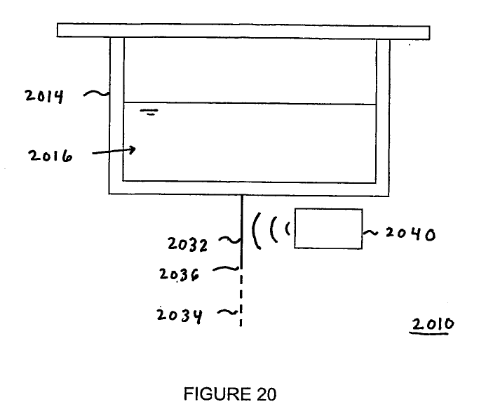

The side-shaker apparatus in FIG. 2 illustrates one method of applying a transverse disturbance. Other methods can be used to apply a transverse disturbance to a capillary stream including magnetic, electrical or acoustic forces. For example, FIG. 20 illustrates a transverse perturbation apparatus 2010 in which the transverse disturbance is generated acoustically. The apparatus 2010 comprises a reservoir 2014 holding molten metal 2016, which is ejected from a orifice in the bottom of the reservoir 2014 to form a capillary stream 2012. Due to capillary stream break-up, the capillary stream breaks up into a droplet stream 2034. In this embodiment, an acoustic wave generator 2040 directs transverse acoustic waves to the capillary stream 2032 above the stream's break-up point 2036 to apply the transverse disturbance.

FIGS. 3 and 4 shows a comparison of the response of the capillary stream to the side-shaker or transverse disturbance mode of droplet formation to the plunger mode for twenty five frequencies in the range of 5520-17040 Hz in frequency increments of 480 Hz. The droplet fluid in this example is solder and the stream speed and stream diameter are measured to be 5.09 m/s and 180 μm, respectively. FIG. 3 illustrates droplets generated from the side-shaker mode and FIG. 4 illustrates droplets generated from the plunger mode. The input droplet waveform was a sinewave in both realizations. For later discussion, the case when the input frequency was 11,280 Hz is indicated in FIGS. 3 and 4. It can be seen that in almost all cases, the side-shaker mode results in shorter break-up lengths, which has the same effect as increasing the power to the piezoelectric crystal that initiates the disturbance on the stream. Furthermore, the piezoelectric crystal in the plunger-mode apparatus is roughly twice the physical diameter as that in the side-shaker mode apparatus—a modification that was adopted to achieve enough amplitude for droplet formation in the same optical viewport as in the case of the side-shaker mode.

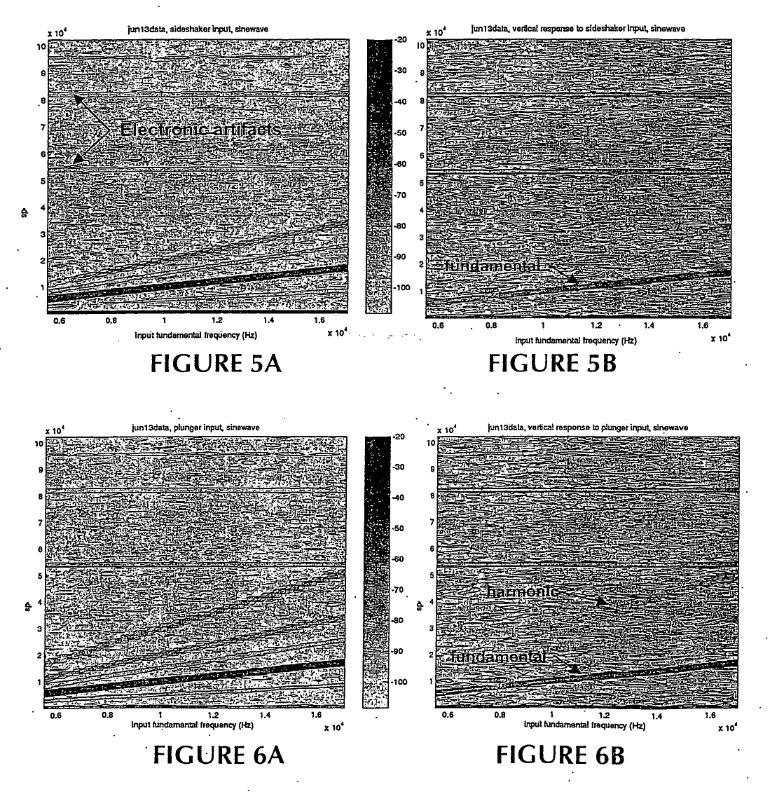

The acoustic response of the droplet generators is illustrated in FIGS. 5A and 5B and 6A and 6B. FIGS. 5A and 5B, respectively, illustrate the spectra of the input signal to the apparatus and the acoustic response of the side-shaker apparatus for a sinewave excitation from 5520 to 17040 Hz. The abscissa is the forcing frequency (i.e., 25 experimental realizations from 5520 to 17040 Hz in increments of 480 Hz) and the ordinate is the spectral amplitude. Note that the horizontal lines at approximately 54,000 and 83,000 Hz are artifacts of the electronics (i.e., the peaks appear when there is no forcing disturbance applied to the apparatus but the accelerometer amplifier is turned on). FIGS. 6A and 6B are the corresponding plots for the plunger mode of droplet generation illustrated as a comparison. It should also be noted that the photographs illustrated in FIGS. 3 and 4 were taken for the same conditions (and at the same time) as the spectral contour plots in FIGS. 5A and 5B and 6A and 6B. The differences between the two contour plots are small and are mainly the more predominate appearance of a well-defined harmonic component in the case of the plunger-mode response (indicated on the plot) that is not as predominant in the side-shaker response.

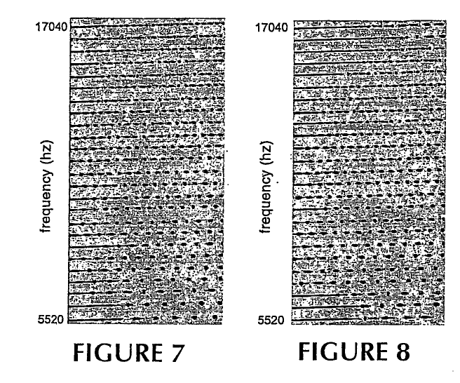

The response of both generators to a square-wave forcing disturbance are illustrated in FIGS. 7 and 8. FIG. 7 illustrates the droplet streams generated from the side-shaker apparatus with a square wave perturbation and FIG. 8 is the corresponding droplet stream responses from the plunger mode. A pronounced difference in the break-up length is observed, especially at the high frequencies. In almost every case, the droplets generated from the side-shaker mode are formed at much earlier times than the plunger counterpart. Again, this is the same effect as increasing the power to the piezoelectric crystal, which would in turn; increase the amplitude of the perturbation on the capillary stream. Hence, it is fair to state that the side-shaker mode of droplet formation is more efficient than the plunger mode of perturbation, since it requires less power to achieve capillary stream break-up at a given location (substantiating this is the fact that the actual piezoelectric crystal element on the plunger mode is larger than that of the side-shaker).

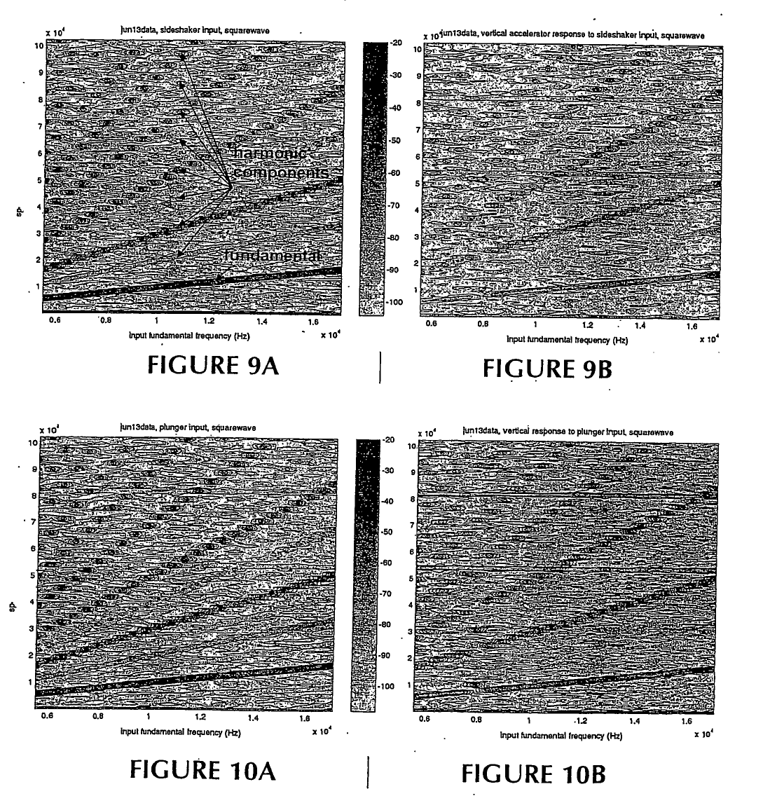

The acoustic response of the two generators is illustrated in the spectral contour plots of FIGS. 9A and 9B and 10A and 10B. FIGS. 9A and 9B, respectively, illustrate the spectra of the input disturbance and the response of the side-shaker apparatus subject to a square wave perturbation for the same frequency range presented in FIGS. 3-8. It is clearly evident that the square wave perturbation results a rich display of higher-order harmonics in the input, which are communicated to the apparatus response in both cases of the side-shaker and plunger mode. A notable difference between the response of the two droplet generators is that the side-shaker mode has clearly less noise as indicated by a comparison of the background intensity between the two right plots in FIGS. 9A and 9B and 10A and 10B.

Furthermore, the response of the side-shaker apparatus has less noise than the actual input. Hence, it has been demonstrated that the side-shaker mode is a more efficient mode of droplet generation for both a sine-wave and square wave disturbance.

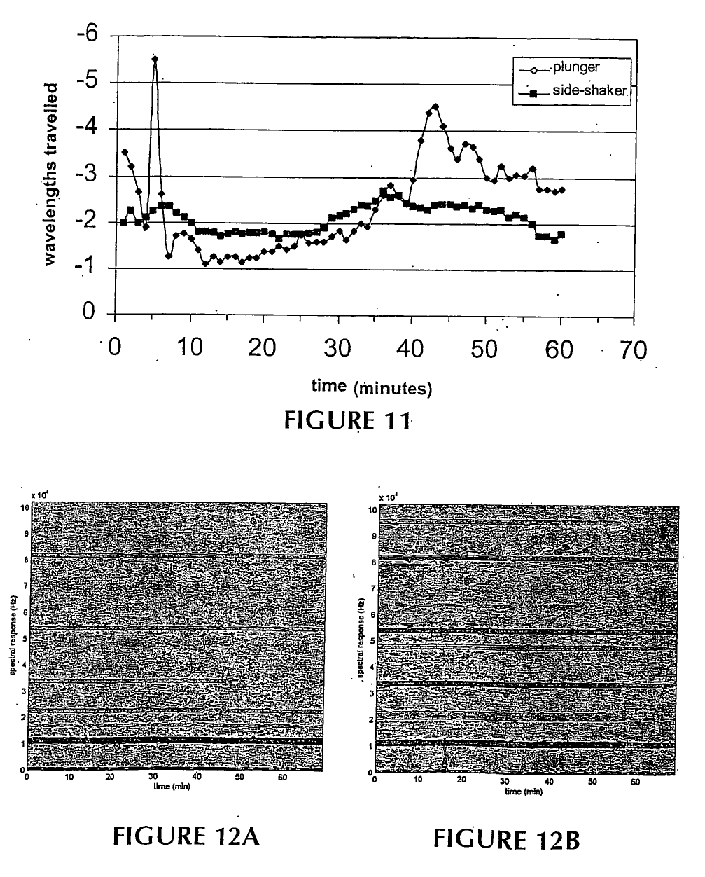

However, more importantly, it is also demonstrated that the side-shaker mode of droplet formation results in a more stable droplet formation location—a critical issue for applications depending on electrostatic charging and deflection. FIG. 11 illustrates the movement of the droplet formation location over a period of 60 minutes for a droplet stream generated with a sine wave disturbance of 11280 Hz (indicated in FIGS. 3 and 4). The square symbols refer to the side-shaker mode and the diamonds refer to the plunger mode of droplet generation. Variations in droplet formation time are a result of the establishment of standing waves within the fluid of the reservoir. As the fluid level decreases due to the emanation of the capillary stream, the acoustic response of the apparatus will change. As evidenced in FIG. 11, the variation in droplet formation location is significantly less in the case of the side-shaker mode of generation due to the fact that with this mode the effects of standing waves in the fluid reservoir are secondary.

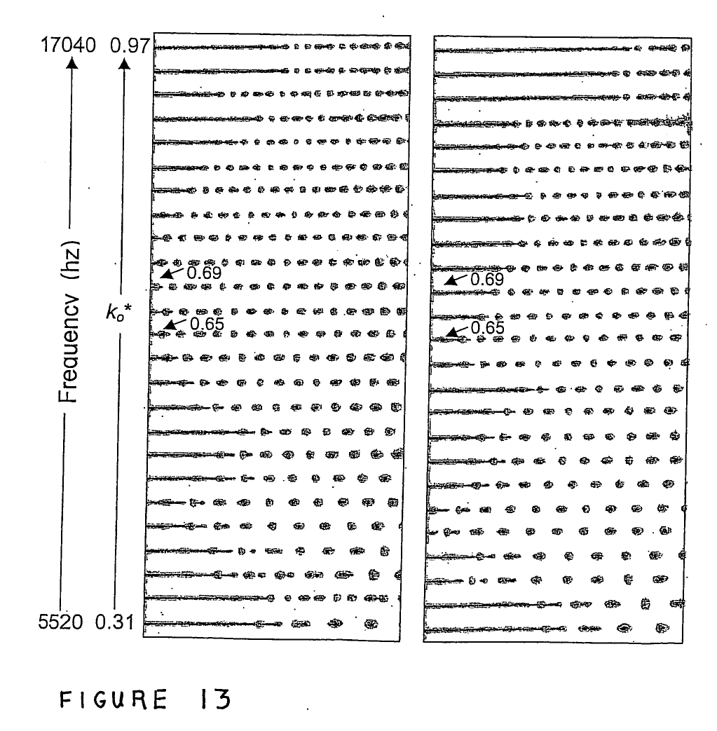

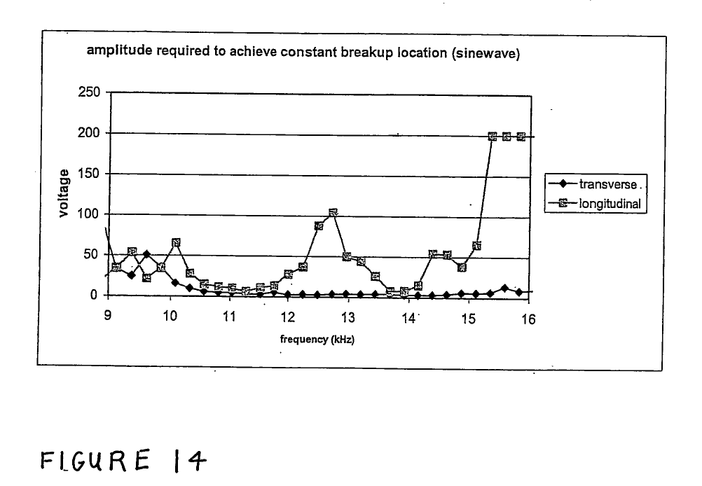

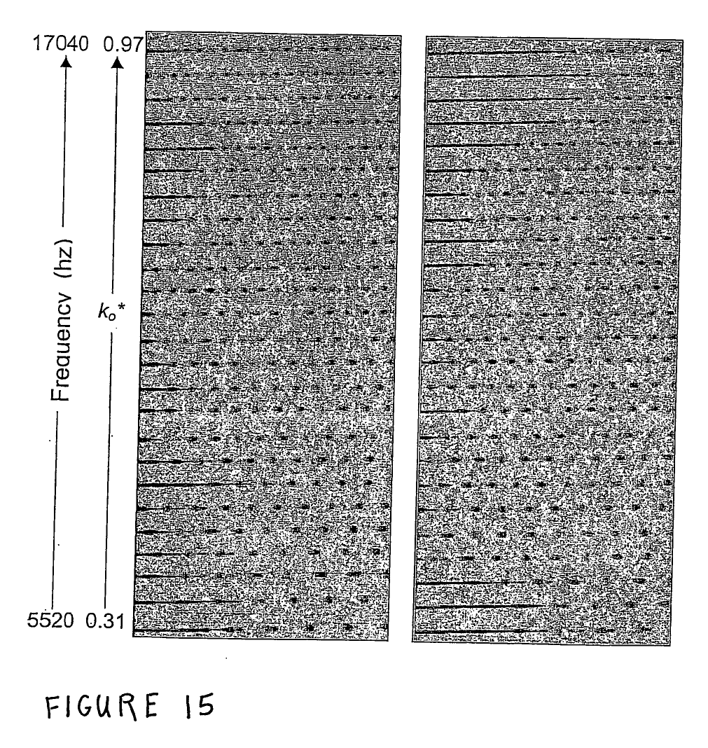

Contour plots of the spectral responses of the side-shaker mode and the plunger mode of droplet generation are illustrated in FIGS. 12A and 12B for a time period of 70 minutes. The plot in FIG. 12A represents the spectral response of the side-shaker and the plot in FIG. 12B is for the plunger mode. It is apparent that the side-shaker mode exhibits less noise over the broad range of frequencies, and predominantly less variance as evidenced in the spectral amplitude at low frequencies for the plunger mode. Additionally, the amplitude of the fundamental disturbance decays dramatically near 57 minutes for the plunger-mode, where the amplitude of the fundamental disturbance is constant over the evaluated time period for the side-shaker mode.

In order to present a fair comparison, the above experimental results presented in FIGS. 11 and 12 were obtained for sine-wave perturbation at a frequency of 11280 hz, which, by examination of FIGS. 3 and 4 result in stable droplet formation with short break-up times for both modes of droplet formation. More radical differences in the stability of the droplet formation point (in favor of the side-shaker) have been observed at frequencies conducive to a shorter breakup length for the side-shaker.

A second study was conducted to further compare the side-shaker or transverse mode apparatus to the plunger mode apparatus. For the measurements in this study we have used an orifice with a measured diameter of 103 μm, and a droplet fluid of molten solder (63/37 tin/lead alloy) which has a density of 8218 kg/m³ in the molten state. The capillary stream traveled with a measured stream speed of 5.09 m/s. We observed the droplet stream's response to both modes of droplet generation (transverse and longitudinal) for frequencies in the range of 5520 to 17040 Hz in frequency steps of 480 Hz. This corresponded to a range in nondimensional wavenumber, kₒ^{*}, of 0.31 to 0.974, where kₒ^{*} is the ratio of the initial stream circumference to the wavelength of the imposed disturbance. When kₒ^{*} is in the Rayleigh range of zero to one, the imposed disturbance causes an unstable radial disturbance on the surface of the capillary stream which grows until droplets are pinched off from the stream.

Measurements were made at a location 5.2 mm from the exit face of the orifice. We have measured the stability of the capillary stream breakup location in terms of perturbation wavelength, λ, since for charging applications, it is desirable to maintain the breakup location within at least one wavelength. Recall that the perturbation wavelength, λ, is the ratio of the stream circumference, 2πr₀, where r₀ is the radius of the unperturbed stream, to nondimensional wavenumber, k₀^{*}, and is also the resulting average center-to-center droplet separation. For the orifice size and capillary stream speed employed in this work, the range in kₒ^{*} from 0.31 to 0.974 corresponds to a range in perturbation wavelength of 298 μm to 924 μm, (including the effects of the vena-contracta of the capillary stream after it exits the nozzle).

FIG. 13 shows a comparison of the response of the capillary stream to the transverse mode of droplet formation (shown on the left) to the longitudinal mode (shown on the right) for the range of frequencies discussed above. The input droplet waveform was a sine wave in both realizations. Recall that an inviscid fluid will have a kₒ^{*}ₘₐₓ equal to 0.697, where kₒ^{*}ₘₐₓ is the kₒ^{*} at which the growth rate of the radial disturbance on the stream's surface is greatest. Molten solder can be assumed to be inviscid and should have the shortest capillary stream breakup distance when perturbed with a waveform characterized with kₒ^{*}=0.697. It can be seen that for the transverse mode of droplet generation (shown on the left) that the shortest breakup location corresponds to kₒ^{*}=0.69; the theoretical value for all intents and purposes. However, the shortest capillary stream breakup location for the longitudinal mode occurs at kₒ^{*}=0.65 as indicated in the photograph. This small deviation from theoretical value is likely due to the imposition of added frequency components to the apparatus when employing the longitudinal mode of droplet generation.

It can be seen that in almost all cases, the transverse mode results in shorter break-up lengths than the longitudinal mode. Shorter breakup lengths have same the practical effect of increasing the power to the piezoelectric crystal that initiates the disturbance on the stream. Hence, from first observations, the transverse mode of droplet generation is more efficient than the longitudinal mode. To corroborate this finding, it should also be mentioned that the piezoelectric crystal in the longitudinal-mode apparatus is roughly twice the physical dimensions as that in the transverse mode apparatus—an apparatus modification that was necessary in order to achieve enough amplitude for droplet formation to occur within the same optical view port of the facility as in the case of the transverse mode.

To corroborate the issue of efficiency further, FIG. 14 illustrates the voltage required to achieve droplet formation at the location of 5.2 mm from the exit face of the orifice for both modes of droplet generation. Here, the frequencies are varied in the range of 9,000 to 16,000 Hz, corresponding to a range in kₒ^{*} of 0.51 to 0.92. It can be seen that for almost every case the voltage required is less in the transverse mode as for the longitudinal mode. Furthermore, the voltage level is almost constant in the transverse mode whereas it is quite variable in the longitudinal mode, necessitating “tuning” during operation in order to maintain a constant droplet formation location which is a necessary requirement for precise printing with electrostatically charged droplets.

The response of both generators to a square-wave forcing disturbance was also investigated and the results are illustrated in FIG. 15. The droplet traces on the left are photographs of droplet streams generated from the transverse apparatus with a square wave perturbation and on the right are photographs of droplet streams generated with the longitudinal mode. A pronounced difference in the break-up length is observed, especially at the high frequencies. In almost every case, the droplets generated from the transverse mode are formed at much earlier times than the longitudinal counterpart. Again, this is the same effect as increasing the power to the piezoelectric crystal, which would in turn; increase the amplitude of the perturbation on the capillary stream. Hence, it is fair to state that the transverse mode of droplet formation is more efficient than the longitudinal mode of perturbation; since it requires less power to achieve capillary stream break-up at a given location (substantiating this is the fact that the actual piezoelectric crystal element on the longitudinal mode is larger than that of the transverse).

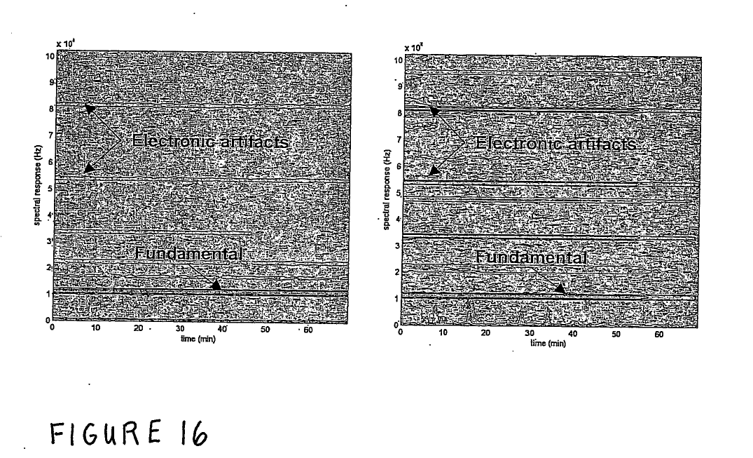

We have examined the acoustic response of the apparatus to both modes of droplet generation. FIG. 16 illustrates the contour plot of the spectral amplitude of the apparatus response over a 70 minute period when the stream is perturbed with a sine wave disturbance with k₀*=0.65 and frequency of 11,280 Hz, (i.e., the droplet conditions indicated on FIG. 13 for the shortest breakup length in the longitudinal mode). The plot on the left corresponds to droplet stream perturbation in for the transverse mode and on the right to the longitudinal mode. The solid horizontal line at 11,280 Hz on both plots is the input frequency. The horizontal bands near 54 and 83 kHz are electronic artifacts inasmuch as they appear when the accelerometer is powered up but not connected to the apparatus.

An important finding that is demonstrated is that the transverse mode of droplet formation generally results in less noise transmitted to the apparatus as evidenced by the overall “cleaner” background. It is apparent that the transverse mode exhibits less noise over the broad range of frequencies, and predominantly less variance as evidenced in the spectral amplitude at low frequencies for the longitudinal mode. Additionally, the amplitude of the fundamental disturbance decays dramatically near 57 minutes for the longitudinal-mode, where the amplitude of the fundamental disturbance is constant over the evaluated time period for the transverse mode.

Finally, we have measured the stability of the droplet formation location (i.e., the constancy of the capillary stream breakup point) over a one hour period for both modes of droplet generation and for a five different forcing conditions (i.e., k₀*=0.32, 0.51, 0.65, 0.81 and 0.97). Recall that the reliability of droplet “printing” or “targeting” relies on the invariance of the droplet formation location. Variability in droplet formation location leads to large errors in droplet charge (and hence, targeting) since the droplet charging waveform is carefully synchronized with the predicted droplet formation location.

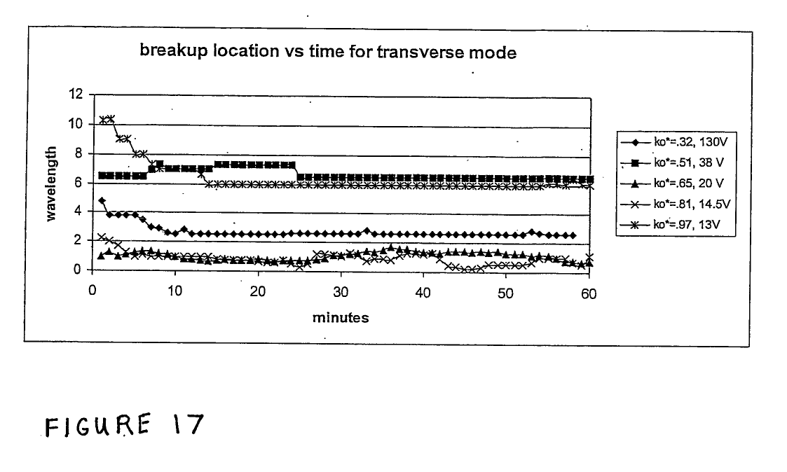

FIG. 17 illustrates our measurements of the droplet formation location stability for the transverse mode of droplet generation for five different sine wave frequencies. The deviation from the breakup location is measured in perturbation wavelength (discussed in section 4 above). It can be seen that after the initial start-up transient (predominantly in cases when kₒ^{*} is far from kₒ^{*}ₘₐₓ, i.e., kₒ^{*}=0.32 and 0.97), the breakup location exhibits extremely low variance. It should also be noted that the transverse mode of droplet generation is so efficient that for the cases when the breakup location is quite short (i.e., kₒ^{*}=0.65 and 0.81) the voltage to the piezoelectric crystal had to be reduced significantly (from 130V to 14.5 and 20 V respectively as indicated in the figure legend) in order to extend the breakup to be within the view port of the apparatus. Hence the variability of ±1 wavelength could likely be reduced by perturbing the stream with a higher amplitude disturbance.

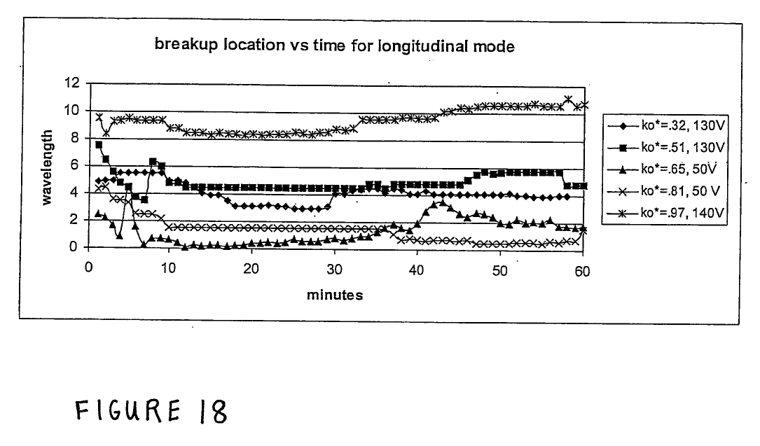

FIG. 18 illustrates variation in breakup location over a one hour period for the longitudinal mode of droplet generation for the same perturbation wavenumbers as used for the transverse mode discussed above. It can be seen that this mode results significantly more variability in droplet formation location than the transverse mode. Moreover, the voltage to the piezoelectric crytal is higher in every experimental realization, due to the fact that the longitudinal mode is less efficient than the transverse mode.

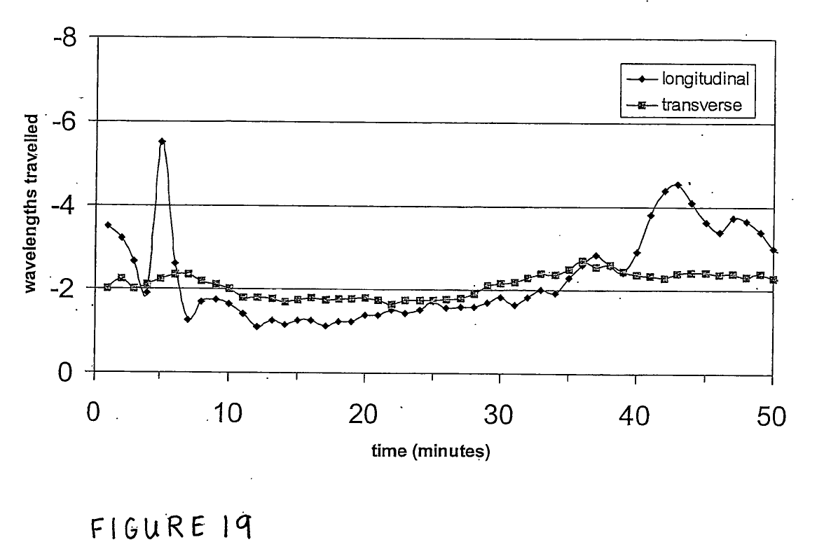

A comparison of the variation in droplet formation location for streams generated with both modes of generation and a kₒ^{*}=0.65 is presented in FIG. 19. Recall from FIG. 13 that kₒ^{*}=0.65 corresponds to the shortest capillary stream breakup location for the longitudinal mode of droplet formation, and hence this condition should result in the most stable droplet formation. This is because previous results have shown that the droplet streams exhibit less variability when perturbed with a frequency that leads to the shortest capillary stream breakup location. Hence, even for the best-case longitudinal mode droplet formation (which does not correspond to the best-case transverse mode), the longitudinal exhibits significantly more variability in droplet formation location than the transverse mode.

Variations in droplet formation time are a result of the establishment of standing waves within the fluid of the reservoir. As the fluid level decreases due to the emanation of the capillary stream, the acoustic response of the apparatus will change. As evidenced in FIGS. 17-19, the variation in droplet formation location is significantly less in the case of the transverse mode of generation due to the fact that the with this mode, the effects of standing waves in the fluid reservoir are secondary.

Although sine waves and square waves were used to impose the transverse disturbances in the measurements, other waveforms may be used. For example, a waveform comprising a superposition of more than one sine wave frequency can be used. Other examples include amplitude modulated sine waves, sine waves with added harmonics and a sawtooth wave. Whatever waveform is used, it is important that the waveform impose a periodic disturbance with a fundamental disturbance in the Rayleigh range (i.e., the wavenumber, kₒ^{*}, is between zero and one). The waveform may impose other disturbances which may be derived by the superposition of more than one disturbances and the other frequencies may be outside of the Rayleigh range.

Also, the invention is not limited to the frequency ranges quoted in the measurements. Other frequencies may be used depending on the stream speed and the orifice size.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

1. A capillary stream droplet generator comprising
a reservoir,
an orifice plate coupled to the reservoir,
an orifice coupled to the orifice plate and in fluid communication with the reservoir, and
a transverse disturbance generating member coupled to the orifice plate.

2. The droplet generator of claim 1 wherein the disturbance generating member includes a piezoelectric crystal.

3. The droplet generator of claim 2 wherein the disturbance generating member further comprises a piezoelectric crystal restraining mass coupled to the piezoelectric crystal.

4. The droplet generator of claim 1 further comprising a shock absorbing gasket interposing the orifice plate and reservoir.

5. The droplet generator of claim 1 further comprising a ball interposing the orifice plate and the disturbance generating member.

6. The droplet generator of claim 1 wherein the orifice plate has a rectangular cross section.

7. A method of generating droplets from capillary stream breakup comprising the steps of
generating a capillary stream of material,
applying a transverse disturbance to the stream, and
forming droplets from the stream.

8. The method of claim 7 wherein the applying a disturbance step comprising exciting a piezoelectric crystal.

9. The method of claim 8 wherein the exciting step comprising applying a sine wave excitation to the piezoelectric crystal.

10. The method of claim 8 wherein the exciting step comprising applying a square wave excitation to the piezoelectric crystal.

11. The method of claim 7 wherein the generating a capillary stream comprising ejecting the material from an orifice.

12. The method of claim 11 wherein the applying a disturbance step comprising vibrating the orifice in a direction orthogonal to an axis of the stream.

13. The method of claim 12 wherein the applying a disturbance step comprising exciting a piezoelectric crystal coupled to the orifice.

14. The method of claim 7 wherein the applying a disturbance step comprising applying a traverse acoustic wave to the capillary stream.

15. A capillary stream droplet generator comprising
a reservoir adapted to hold motel metal,
an orifice in fluid communication with the reservoir, wherein the molten metal is ejected from the orifice to form a capillary stream, and
an acoustic wave generator adapted to direct a transverse acoustic wave to the capillary stream.

16. The droplet generator of claim 15, wherein a wavenumber, k₀*, is between zero and one, where the wavenumber, k₀*, is the ratio of an initial circumference of the capillary stream to a wavelength of the transverse acoustic wave.

17. The droplet generator of claim 15, wherein the acoustic generator directs the transverse acoustic wave above a break-up point of the capillary stream.

18. The droplet generator of claim 15, wherein the orifice is formed in the bottom of the reservoir.
